(19) United States
(12) Patent Application Publication
(10) Pub. No.: US 2021/0177019 A1
(43) Pub. Date: Jun. 17, 2021

(54) PASTRAMI PRODUCT AND METHODS OF MAKING SAME

(71) Applicant: Yaacov Silberstein, Glen Head, NY (US)

(72) Inventor: Yaacov Silberstein, Glen Head, NY (US)

(21) Appl. No.: 17/117,716

(22) Filed: Dec. 10, 2020

Related U.S. Application Data
(60) Provisional application No. 62/946,670, filed on Dec. 11, 2019.

(51) Int. Cl. A23L 13/00; A23L 13/40; A23L 5/10; A23P 30/10; A23L 27/10; A23L 29/30; A23L 33/125

(52) U.S. Cl. CPC A23L 13/03; A23L 13/428; A23L 5/19; A23L 33/125; A23L 27/10; A23L 29/30; A23P 30/10

(57) ABSTRACT

A method of making a pastrami roll includes providing a raw meat, applying a brine to the raw meat, covering the raw meat with spices after the brine is applied, cooking the raw meat in an oven at a first temperature for a first duration to make a cooked pastrami, cutting the cooked pastrami into pastrami portions, mixing the pastrami portions with a binder to create a composite, the binder including trimmings and lean meat, cooking the composite in an oven at a second temperature for a second duration, and packaging the cooked composite.

### CROSS-REFERENCE TO RELATED APPLICATIONS

The present application claims priority to U.S. Provisional Ser. No. 62/946,670, filed Dec. 11, 2019, entitled “PASTRAMI ROLL AND METHODS OF MAKING SAME,” the entirety of which is hereby incorporated by reference as if fully set forth herein.

### FIELD OF THE DISCLOSURE

The present disclosure relates to methods of making pastrami products. More particularly, the present disclosure relates to a pastrami roll or sliced pastrami product made from pastrami ends & trimmings and methods of making same.

### BACKGROUND OF THE DISCLOSURE

Pastrami is a meat product formed by brining/pickling raw meat for a duration of time, seasoning it, then cooking the meat. In some examples, the meat is a brisket or other tough cut that benefits from a long cooking process. In retail and wholesale applications, after slicing the finished pastrami, certain portions are not used or are unsuitable for sale. These may include, for example, the ends and trimmings of the pastrami, which are often discarded or sold at a loss.

Thus, it would be helpful to utilize these unused pastrami portions (e.g., ends) to create a new and edible product.

### SUMMARY OF THE DISCLOSURE

A method of making a pastrami roll includes providing a raw meat, applying a brine/pickle to the raw meat, covering the raw meat with spices after the brine is applied, cooking the brined/pickled raw meat in an oven at a first temperature for a first duration to make a cooked pastrami, cutting the cooked pastrami into pastrami portions, mixing the pastrami portions with a binder to create a composite, the binder including trimmings and lean meat, cooking the composite in an oven at a second temperature for a second duration, and packaging the cooked composite.

### BRIEF DESCRIPTION OF THE DISCLOSURE

Various embodiments of the presently disclosed products and methods are described herein with reference to the drawings, wherein:

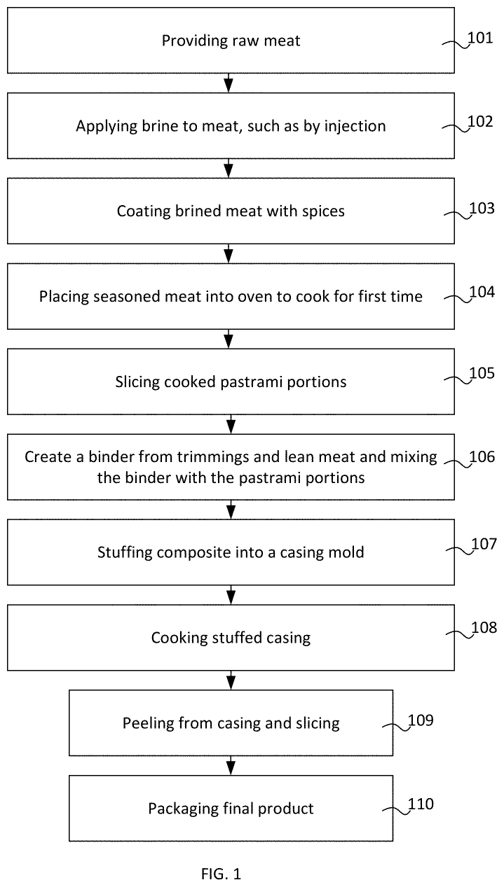

FIG. 1 illustrates one general process of making a pastrami roll;

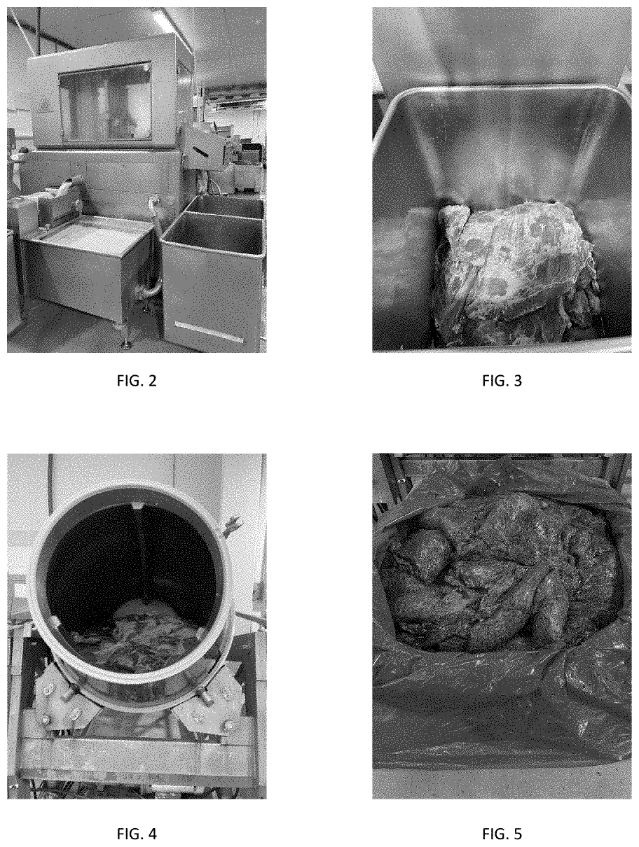

FIGS. 2-12 are photographs showing several steps in the process of making a pastrami roll; and

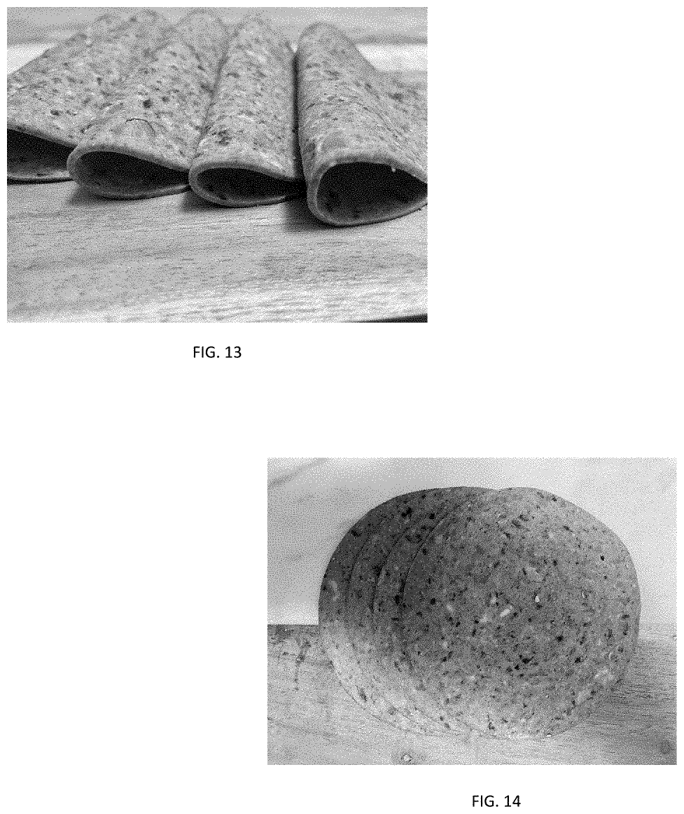

FIGS. 13-14 are photographs showing several steps in the process of making pastrami slices according to one embodiment.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to pastrami products, conventional methods suffer from some of the shortcoming described above.

There therefore is a need for further improvements to the methods of making pastrami products in order to attain a greater yield of the raw meat used. Among other advantages, the present disclosure may address one or more of these needs.

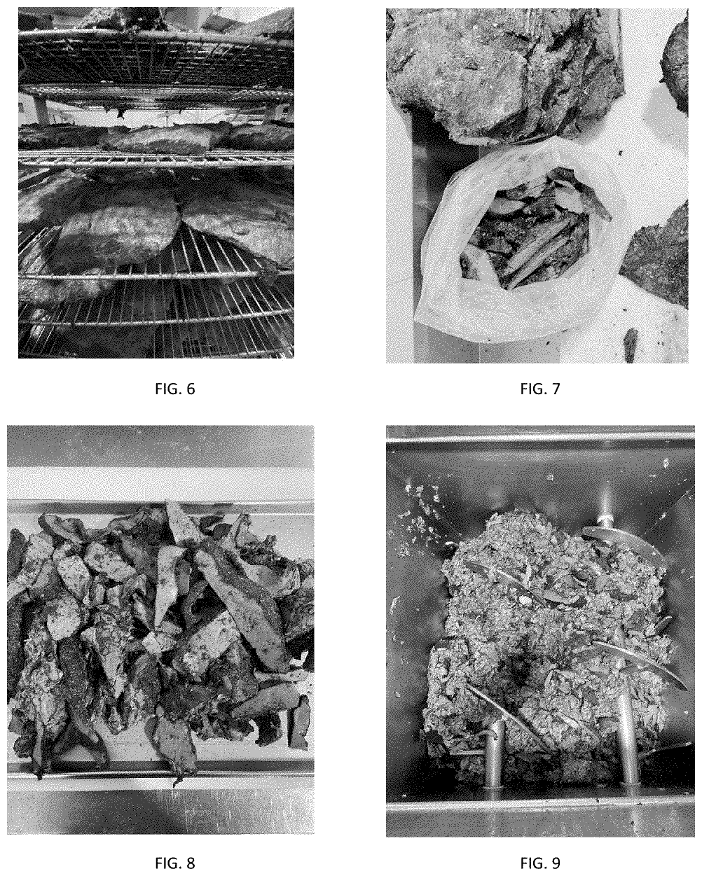

FIG. 1 illustrates the general process of making a pastrami roll according to one embodiment. First, a raw meat is provided (step 101). This raw meat may be a brisket, plate, navel, deckel, or top of rib. Brine (e.g., water, salt, cure and other seasonings) may be applied to the meat (step 102). In some examples, the brine is applied via injection into the meat. Additionally or alternatively, the raw meat may be put into a brine/pickle for a period of time. FIGS. 2 and 3 show photographs of raw meat being injected with brine, and injected meat, respectively. The brined meat will then be coated with species on all sides (step 103). These spices may include, for example, black pepper, coriander, sugar, caramel color and other seasonings. FIG. 4 is a photograph showing brined meat being mixed with spices, and FIG. 5 is a photograph showing seasoned meat that is ready for cooking. The seasoned meat may then be placed into an oven to be cooked for a first time at various temperatures until the meat reaches an internal temperature of between 150-170 degrees, or at least 155 degrees Fahrenheit (step 104). The meat is then chilled before being sliced. FIG. 6 shows cooked pastrami being taken out of an oven. The finished product is a cooked pastrami which may be sliced and/or trimmed to create pastrami portions (step 105). FIG. 7 is a photograph showing the pastrami being trimmed and FIG. 8 is a photograph showing the pastrami portions.

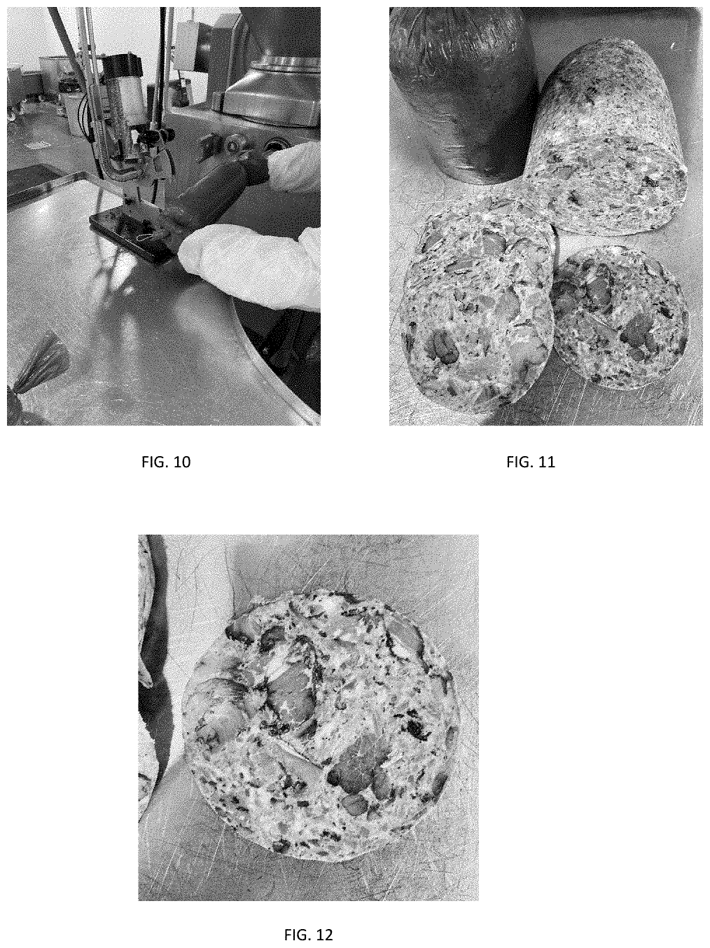

In at least some examples, a binder is created from trimmings and lean meat and the cooked pastrami is mixed with the binder to create a composite (step 106). FIG. 9 is a photograph showing the pastrami being mixed with the binder. This composite of pastrami and binder is stuffed into a casing mold (step 107) as shown in FIG. 10. The stuffed casing may be cooked at various temperatures until the internal temperature reaches between 150-170 degrees, or at least 159 degrees Fahrenheit (step 108). In this instance, the second cooking time may be enough to cook the composite and the binder. Optionally, the casing is peeled and the final product is sliced (step 109) as shown in FIGS. 11 and 12. Regardless of whether the casing is peeled, the final product is a pastrami roll that is packaged for sale and ready for consumption (step 110).

One example of making a binder and mixing it with the pastrami portions begins with the following ingredients:

| Ingredients | Percentage |
|---|---|
| Trimmings and lean meat | approximately 54% by weight |
| Pastrami Pieces, cut uniform size | approximately 36% by weight |
| Water | approximately 7% by weight |
| Salt, cure, sodium erythorbate, | approximately 3% by weight. |
| sodium phosphates, spices, sodium | |
| lactate, sodium diacetate, smoke | |
| flavor | |

In this example, the pastrami roll is processed as follows:
1) Grind lean meat
2) Grind trimmings
3) Place the lean meat into a mixer with the salt, cure, sodium erythorbate and sodium phosphates and turn on and mix.
4) Add the water and smoke And Mix.
5) Add the spices, lactate/diacetate and trimmings. Mix.
6) Add the pastrami pieces. Mix
7) Remove from mixer and place into stuffer. Stuff into casings or molds
8) Place onto racks and cook in oven at various temperatures until the internal temperature reaches at least 164 degrees Fahrenheit.
9) Chill the Pastrami Roll and either package cooked pastrami roll as is or peel, slice and package.

In this manner, pre-cooked pastrami may be combined with a binder to create a pastrami roll. This pastrami roll may utilize portions of cooked pastrami that would otherwise be discarded (e.g., pastrami ends and trimmings) or unsuitable for other pastrami products. The cooked pastrami roll will include pastrami that has been cooked twice, once to properly cook the pastrami, and a second time to cook with the binder so that the pastrami roll is able to maintain its shape and hold itself together, even when removed from a casing/mold, or sliced.

In some embodiments, the pastrami may be chopped into smaller portions before being added to the binder above to yield a more homogenous mixture with the lean meat/trimmings. In at least some examples, these smaller portions are approximately between ⅛ inch and ¼ inch in size. The smaller pastrami portions yield a more homogenously textured product, and a more homogeneous color when the product is eventually sliced.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. A method of making a pastrami product, comprising:
providing a raw meat;
applying a brine to the raw meat;
covering the raw meat with spices after the brine is applied;
cooking the raw meat in an oven at a first temperature for a first duration to make a cooked pastrami;
cutting the cooked pastrami into pastrami portions;
mixing the pastrami portions with a binder to create a composite, the binder including trimmings and lean meat;
cooking the composite in an oven at a second temperature for a second duration; and
packaging the cooked composite.

2. The method of claim 1, further comprising the step of chopping the cooked pastrami prior to mixing the pastrami portions with the binder.

3. The method of claim 1, further comprising the step of slicing the composite after cooking the composite in the oven at a second temperature.

4. The method of claim 1, wherein the spices comprise at least one of black pepper, coriander, sugar and caramel color.

5. The method of claim 1, wherein cooking the raw meat in an oven at a first temperature comprises the cooking the raw meat into a cooked product until an internal temperature of the cooked product reaches 155 degrees Fahrenheit.

6. The method of claim 1, wherein cooking a composite in an oven at a second temperature comprises cooking the composite until the composite has an internal temperature of 159 degrees Fahrenheit.

7. The method of claim 1, further comprising the step of chilling the composite after cooking the composite in the oven.

8. The method of claim 1, wherein mixing the pastrami portions with a binder to create a composite comprises mixing 54% of trimmings and lean meat with 36% pastrami portions, 7% of water and 3% of additional ingredients.

9. The method of claim 8, wherein the additional ingredients comprise at least one of salt, cure, sodium erythorbate, sodium phosphates, spices, sodium lactate, sodium diacetate, and smoke flavor.

10. The method of claim 1, wherein the raw meat comprises at least one of brisket, plate, navel, deckel or top of rib.

11. The method of claim 1, further comprising the step of stuffing the composite into a casing.

12. A method of making a pastrami product, comprising:
providing a raw meat;
applying a brine to the raw meat;
covering the raw meat with spices after the brine is applied;
cooking the raw meat in an oven at a first temperature for a first duration to make a cooked pastrami;
chopping the cooked pastrami into pastrami portions;
mixing the pastrami portions with a binder to create a composite;
cooking the composite in an oven at a second temperature for a second duration so that the pastrami is cooked twice and the binder is cooked once.
